(19) United States
(12) Patent Application Publication
(10) Pub. No.: US 2002/0175851 A1
(43) Pub. Date: Nov. 28, 2002

(54) Personal safety device

(76) Inventors: Arno Schaumann, Ludwigsburg (DE); Dirk Weber, Stuttgart (DE); Alfred Kuttenberger, Moeglingen (DE)

Correspondence Address: KENYON & KENYON, ONE BROADWAY, NEW YORK, NY, 10004, US

(21) Appl. No.: 10/100,696

(22) Filed: Mar. 18, 2002

(30) Foreign Application Priority Data
Mar. 16, 2001 (DE) 101 12 664.6

(51) Int. Cl. G01S 13/56

(52) U.S. Cl. 342/27; 342/22; 342/56; 342/147

(57) ABSTRACT

A protective device for a person, specifically for a person participating a sport, having at least one sensor device for detecting obstacles in the vicinity of the person to be protected; an evaluation device having a microcontroller for a situation evaluation with respect to the surroundings of the person to be protected; a triggering device for activating a protective application; and a protective application, which can be integrated in the equipment of the person to be protected.

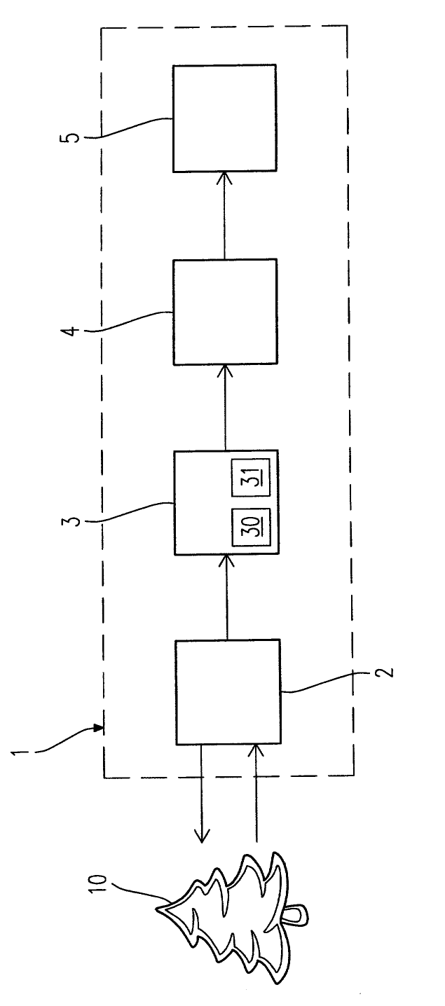

### FIELD OF THE INVENTION

The present invention relates to a protective device for a person, in particular for a person participating in a sport.

### BACKGROUND INFORMATION

Although it is applicable to persons participating in any activities, the present invention and the problem underlying it are discussed with reference to a person participating in a sport, in particular to a skier.

As a result of the ever-increasing number of skiers and of the increasing trend to ski apart from the prepared runs, in recent years the number of skiing accidents due to avalanches or collisions with obstacles has steadily increased. In particular, in the case of skiing through wooded areas, the result is an increase in accidents in which a skier collides with a tree.

Heretofore, systems have become known which protect skiers in the case of avalanches and which increase their survival chances in the event of an avalanche. Among them are transmitting and receiving devices operating on a radio basis.

A further system for protection in response to avalanches is represented by the so-called avalanche airbag. In the event of an avalanche, this device must be triggered by the skier himself. In this context, an airbag located in the backpack of the skier is inflated by a gas cartridge, as a result of which it is intended that the skier remain on the surface of the avalanche and not be covered and crushed by snow.

In the systems as described above, one disadvantage has proven to be the fact that these systems for protecting the skier are limited for use in the case of avalanches. In addition, the systems must be triggered by the skier himself. Therefore, they offer no protection in the event of a skier colliding with an obstacle or the event of a fall in jumping from a ski jump.

### SUMMARY OF THE INVENTION

In contrast to the known solutions, the protective device according to the present invention has the advantage that obstacles are detected and qualified, and, in the event of an unavoidable collision with an obstacle, protective measures can be initiated.

The fundamental idea underlying the present invention can be seen in the fact that the protective device has at least one sensor device for detecting obstacles in the vicinity of the person to be protected; an evaluation device having a microcontroller for evaluating the situation with regard to the surroundings of the person to be protected; a triggering device for activating a protective application; and at least one protective application that can be integrated in the equipment of the person to be protected.

According to one preferred refinement, the sensor device is configured as a radar, ultrasound, infrared, video, and/or laser sensor. In this context, it is possible to provide in the equipment of the person to be protected a plurality of sensors, which operate on varying bases, at varying locations, for example, on the front side or the back side of the equipment.

According to another preferred refinement, the sensor device can be operated actively or passively. On the one hand, in active operation, it is therefore assured that the skier is actively protected from serious injury. On the other hand, in passive operation, it is prevented that a triggering of the protective application is brought about in situations when it is not desired, for example, during travel on ski lifts, etc.

According to another preferred refinement, the evaluation device has a program that has an algorithm for the situation evaluation. In this context, the obstacles located in the immediate vicinity of the person to be protected are qualified and are classified, for example, on the basis of a priority list of different categories of danger.

According to another preferred refinement, a signal is transmitted from the evaluation device to the triggering device in the event that the situation evaluation reveals a probable collision with a dangerous obstacle. Thereupon, the decision is arrived at, in accordance with a predetermined algorithm, as to which situation is to be classified as dangerous, or with respect to which situation a triggering of a protective application is necessary.

According to another preferred refinement, the protective application is configured as at least one airbag, which can be integrated in the clothing of the person to be protected. In this context, it is possible to provide an airbag on the front side, the back side, and/or the side areas of the jacket.

According to another preferred refinement, the triggering device is configured as a firing pellet for activating the airbag.

According to another preferred refinement, the protective application is constituted by opening a ski binding, the triggering device being configured as a device for opening this ski binding. In the event of danger of colliding with an obstacle, a signal can be transmitted from the evaluation device to the triggering device for the automatic opening of the ski binding.

### BRIEF DESCRIPTION OF THE DRAWING

The FIGURE depicts a schematic representation of a protective device according to one exemplary embodiment of the present invention.

### DETAILED DESCRIPTION

The FIGURE illustrates a schematic representation of a protective device according to an exemplary embodiment of the present invention. In this context, the arrows between the individual components, or devices, designate a transmitting, or receiving, of data, or signals, to, or from, the corresponding other device connected to the arrow.

Personal protective device 1 includes a sensor device 2, which is advantageously configured as a radar, ultrasound, infrared, or laser sensor.

Sensor device 2 transmits signals, in order to receive from an obstacle 10 the reflected signals. In this context, the distance between sensor device 2, provided in the protective device 1, and obstacle 10 is determined from the echo time of the signal from sensor 2 to obstacle 10 and back again.

To detect obstacle 10, specifically to measure the distance, it is nevertheless possible to use other devices such as a video sensor.

In particular, at close range, ultrasound sensors are often used due to their very high resolution. Sensor 2 can advantageously be operated either actively or passively, it being advantageous in certain situations such as during travel on ski lifts to operate in a passive mode in order to avoid an undesirable triggering of a protective application. On the other hand, in skiing in wooded areas active operation is advantageous.

Protective device 1 also includes an evaluation device 3, which is connected in a generally familiar manner to sensor device 2. Triggering device 4 receives the signals of sensor device 2 and processes the signals using a microcontroller 30.

In addition, for processing the signals, a program 31 is provided having a specific algorithm in evaluation device 3, it being possible as a result of the evaluation to detect obstacles 10 and to evaluate the situation with regard to the surroundings of the person to be protected. Subsequently, from this evaluation, using the algorithm, it is decided whether a collision with an obstacle 10 is probable. If it is, then a signal is generated which is transmitted to triggering device 4.

Triggering device 4 is also a component part of protective device 1 and is connected in a generally familiar manner to evaluation device 3. Triggering device 4 can be configured, for example, as a firing pellet, which initiates the inflation of an airbag using a gas cartridge.

Protective device 1 also includes a protective application 5, which is connected to triggering device 4 and is activated by it. The task of protective application 5 is to prevent, or to reduce, the serious injuries to the person being protected which could be caused by a collision with obstacle 10. As a possible protective application 5, an airbag is conceivable, which is advantageously provided on the front side of the jacket of the person to be protected. Nevertheless, it is also conceivable to accommodate it on the back side and/or in the side areas of the jacket or in other parts of the equipment of the person to be protected.

In the event of accommodating an airbag in the front side of the jacket of the person to be protected, the airbag opens in the event of detecting an obstacle 10 and of an evaluation to the effect that an injury-causing collision with an obstacle 10 is probable.

Instead of the distance to obstacle 10, it is also possible in the algorithm to use for a situation evaluation other parameters such as velocity, acceleration, size of the obstacle, etc. The decisive factor is that specific protective application 5, in the example described above, the triggering of the airbag in order to protect against chest and/or head injuries, is triggered in the event that evaluation device 3 predicts a probable collision with an injury-causing obstacle 10. It is advantageous to employ a plurality of parameters for the evaluation, in order to be able better to estimate the specific danger of injury.

After use, protective application 5 is advantageously capable of being used again. In the present exemplary embodiment, it is possible, accordingly, after using the airbag, to fold it up once again and to place it in its original position.

Sensor devices 2, or protective applications 5, can be disposed in various areas of the protective equipment of the person to be protected, so as to be able to detect obstacles 10 in different directions and to be able to trigger the appropriate protective applications.

Although the present invention was described above on the basis of one preferred exemplary embodiment, it is not limited thereto, but can be modified in many ways.

For example, with regard to a skier, it is possible for the triggering device 4 to open the ski binding in specific situations.

In addition, as a result of modifications, use is also conceivable in other areas, such as in the case of bicycle riders, motorcycle riders, or in-line skaters, in order to protect the body in response to a collision, for example, with a motor vehicle, or in the case of workers for protection against collisions with working materials or working machines.

What is claimed is:

1. A protective device for a person, comprising:
at least one sensor device for detecting an obstacle in a vicinity of the person to be protected;
an evaluation device including a microcontroller for performing a situation evaluation with regard to surroundings of the person to be protected;
a protective application that can be integrated in an equipment of the person to be protected; and
a triggering device for activating the protective application.

2. The device according to claim 1, wherein:
the person participates in a sport.

3. The device according to claim 1, wherein:
the at least one sensor device includes one of a radar sensor, an ultrasound sensor, an infrared sensor, a video sensor, and a laser sensor.

4. The device according to claim 1, wherein:
the at least one sensor device can be operated one of actively and passively.

5. The device according to claim 1, wherein:
the evaluation device includes a program provided with an algorithm for performing the situation evaluation.

6. The device according to claim 1, wherein:
the protective application includes at least one airbag that can be integrated in a clothing of the person to be protected.

7. The device according to claim 6, wherein:
the triggering device includes a firing pellet for activating the at least one airbag.

8. The device according to claim 1, wherein:
the protective application includes an opening of a ski binding.

9. The device according to claim 8, wherein:
the triggering device includes a device for opening the ski binding.

10. A method for protecting a person, comprising:
detecting an obstacle in a vicinity of the person to be protected using at least one sensor device;
evaluating a situation with respect to surroundings of the person to be protected using an evaluation device; and
if necessary, activating at least one protective application using a triggering device, the at least one protective application being integrated in an equipment of the person to be protected.

11. The method according to claim 10, wherein:
the person is a person participating in a sport.

12. The method according to claim 10, wherein:
the at least one sensor device includes one of a radar sensor, an ultrasound sensor, an infrared sensor, a video sensor, and a laser sensor.

13. The method according to claim 10, wherein:
the at least one sensor device can be operated one of actively and passively.

14. The method according to claim 10, further comprising:
causing the evaluation device to use a microcontroller and a program having an algorithm in order to evaluate the situation.

15. The method according to claim 10, further comprising:
transmitting a signal from the evaluation device to the triggering device if the situation evaluation reveals a probable collision with the obstacle.

16. The method according to claim 10, wherein:
the protective application includes at least one airbag that can be integrated in a clothing of the person to be protected.

17. The method according to claim 16, wherein:
the triggering device includes a firing pellet for activating the at least one airbag.

18. The method according to claim 10, wherein:
the protective application includes an opening of a ski binding.

19. The method according to claim 18, wherein:
the triggering device includes a device for opening the ski binding.
